(19) United States
(12) Patent Application Publication
(10) Pub. No.: US 2005/0151757 A1
(43) Pub. Date: Jul. 14, 2005

(54) Image display apparatus

(76) Inventor: Keith Baker, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,834

(22) PCT Filed: Feb. 12, 2003
(86) PCT No.: PCT/IB03/00511

(30) Foreign Application Priority Data
Mar. 11, 2002 (EP) 02076003.9

(51) Int. Cl. G09G 5/00

(52) U.S. Cl. 345/629

(57) ABSTRACT

A image display apparatus (300) for displaying a third series (104) of consecutive output images (154-158) which are based on a first series (100) of consecutive input images (142-146) and a second series (102) of consecutive input images (148-152), is arranged to split the images of the first series (100) of consecutive input images (142-146) into first parts (106-110) and respective second parts (118-122); to split the images of the second series (102) of consecutive input images (148-152) into third parts (112-116) and respective fourth parts (124-128); and to display a first one (158) of the output images (154-158) comprising a first block of pixels (134) corresponding to a first one (110) of the first parts (106-110) and a second block of pixels (140) corresponding to a first one (128) of the fourth parts (124-128).

The invention relates to an image display apparatus comprising:
first receiving means for receiving a first video signal representing a first series of consecutive input images;
second receiving means for receiving a second video signal representing a second series of consecutive input images; and
a display device for displaying a third series of consecutive output images which are based on the first series of consecutive input images and the second series of consecutive input images.

The invention further relates to a method of displaying a third series of consecutive output images which are based on a first series of consecutive input images and a second series of consecutive input images, comprising:
a first receiving step of receiving a first video signal representing the first series of consecutive input images; and
a second receiving step of receiving a second video signal representing the second series of consecutive input images.

The invention further relates to a TV comprising such an image display apparatus.

In video broadcasting, subtitles are employed to convey textual information to the viewer. The subtitles accompany an audio/video broadcast and provide supplemental information to the viewer that may not be perceivable from the broadcast. Subtitles are frequently used, for example, to aid hearing impaired viewers by displaying the spoken language recorded in the audio soundtrack as written language. Another example, is where subtitles are displayed in different languages than the spoken language recorded in the audio soundtrack. In addition, subtitles may be employed to convey important information not related to the subject matter of the corresponding audio/video broadcast. In this case, subtitles may represent late-breaking news, such as: emergency information; sports scores, weather reports or information of the stock exchange. Frequently the information is provided by means of a banner. The textual information moves relative to the display screen of the display apparatus. Typically the direction of the movement is in a horizontal or vertical direction.

In television broadcasting or video reproduction, such as from a video tape or disk, the subtitles or banners are previously superimposed on the broadcast and become part of the received images. Hence the display of the information of the subtitles or banners is linked with the display of the other video content. In many cases this is a disadvantage. It might be that the user is interested in the textual information conveyed by the banner or subtitle but not in the other video content of the images with which the textual information is linked. E.g. because the user wants to view another channel in the meantime. Some image display apparatus provide a feature which is known as “picture-in-picture”. In patent specification U.S. Pat. No. 5,130,800 is described that multiple pictures from distinct video signals are simultaneously displayed on a display device of one image display apparatus. However in that case the dimensions of the pictures from at least one of the video signals are strongly reduced by means of sub-sampling. This sub-sampling has a negative influence on the readability of banners or subtitles.

It is an object of the invention to provide an image display apparatus of the kind described in the opening paragraph on which parts of images originating from a first series of input images can be displayed simultaneously with images from a second series of input images while the visibility of relevant information conveyed by means of the parts is maintained.

The object of the invention is achieved in that the image display apparatus is arranged:
to split the images of the first series of consecutive input images into first parts and respective second parts;
to split the images of the second series of consecutive input images into third parts and respective fourth parts; and
to display a first one of the output images comprising a first block of pixels corresponding to a first one of the first parts and a second block of pixels corresponding to a first one of the fourth parts.

Relevant parts are selected from the series of input images and combined to output images to be displayed. This is particularly advantageous in the case that textual information is conveyed by means of a banner or subtitle. Then parts of images originating from the first series of input images are displayed simultaneously with parts of images from the second series of input images while the readability of textual information conveyed by means of the parts is maintained.

An embodiment of the image display apparatus according to the invention comprises user interface means to provide location information of the first parts to control splitting of the images of the series of consecutive input images. It is assumed that in a default display mode of the image display apparatus the entire display device is updated on a regular base with images from only one of the series of input image. However if the received input images comprise distinct parts then it is advantageously to split the images in first parts and second parts and to control the display of the first parts independently of the second parts. Location information of the first parts relative to the second parts is required in order to split the received input images. A first option is that the user of the image display apparatus provides this information. E.g. by dragging a graphics box or by manipulation of a graphics line being displayed on the display device as a kind of overlay. Automatic segmentation of the input images is another option to determine the location information. Motion estimation is a good basis for this segmentation. Alternatively the location information is provided by means of the broadcast.

An embodiment of the image display apparatus according to the invention comprises a first memory device for storage of the location information. The location information is relatively constant. By storing the location information it is no longer required to determine or provide the location information again. Optionally multiple instances of the location information are stored as a presetting for the various broadcasting channels. In that case a user of the image display apparatus might start the required display mode, i.e. split display mode, with one push of a button of the remote control. Optionally the image display apparatus automatically switches from a default display mode in which the entire display device is updated on a regular base into the split display mode. This switching might be triggered by a “banner-event”, i.e. the presence of a banner is detected.

An embodiment of the image display apparatus according to the invention comprises scaling means to scale the first parts. Suppose that in a default splitting both images of the first series and the images of the second series are split on basis of the same location information. E.g. at ¼ of the height of the images. That means that the first parts correspond with ¾ of the respective input images of the first series, the second parts correspond with at ¼ of the respective input images of the first series, the third parts correspond with ¾ of the respective input images of the second series, and the fourth parts correspond with at ¼ of the respective input images of second first series. In that case a first one of the first parts is directly combined with a first one of the fourth parts. However if the splitting for the images of the distinct series is not on basis of the same location information then a scaling can be applied to a group of parts. E.g. if the splitting of the images of the second series is at ⅙ of the height and the splitting of the images of the second series is at ¼ of the height then a vertical scaling of 3/2 of the fourth parts should be applied. This results in output images comprising copies of the first parts and vertically scaled versions of the fourth parts. Scaling of both fourth and first parts is an alternative approach.

An embodiment of the image display apparatus according to the invention comprises processing means to assign a new color value to a first pixel of the second block of pixels on basis of an original color value of the first pixel. A color adaptation of the pixels of one of the groups of blocks is advantageous if it is required to inform the viewer of the image display apparatus about the display mode: split display mode. In other words, the viewer can easily observe that the output images are based on distinct series of input images. Besides that, the readability of the information can be enhanced by means of color adaptation. Alternatively the luminance of the pixels of one of the groups of blocks is adjusted independent from the pixels of the other group of blocks. In a preferred embodiment a LUT (Look-Up-Table) is applied for the color adaptation.

It is a further object of the invention to provide a method of the kind described in the opening paragraph with which parts of images originating from a first series of input images can be displayed simultaneously with images from a second series of input images while the visibility of relevant information conveyed by means of the parts is maintained.

This object of the invention is achieved in that the method comprises:
a first splitting step of splitting the images of the first series of consecutive input images into first parts and respective second parts;
a second splitting step of splitting the images of the second series of consecutive input images into third parts and respective fourth parts; and
a display step of displaying a first one of the output images comprising a first block of pixels corresponding to a first one of the first parts and a second block of pixels corresponding to a first one of the fourth parts.

Modifications of the image display apparatus and variations thereof may correspond to modifications and variations thereof of the method described.

These and other aspects of the image display apparatus, of the TV and of the method according to the invention will become apparent from and will be elucidated with respect to the implementations and embodiments described hereinafter and with reference to the accompanying drawings, wherein:

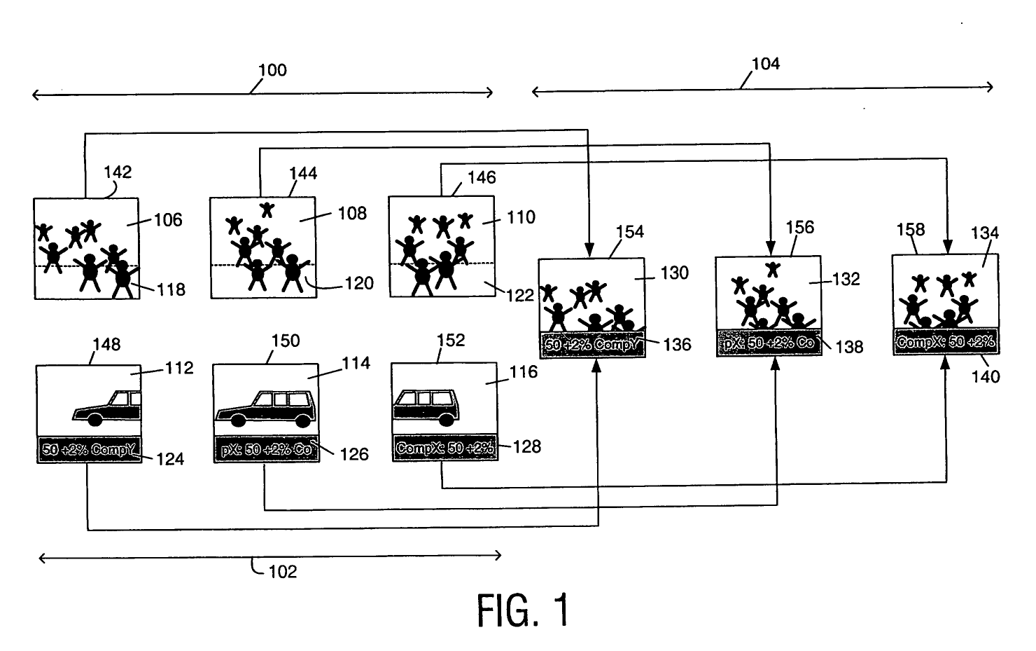

FIG. 1 schematically shows two series of input images and a series of output images according to the invention;

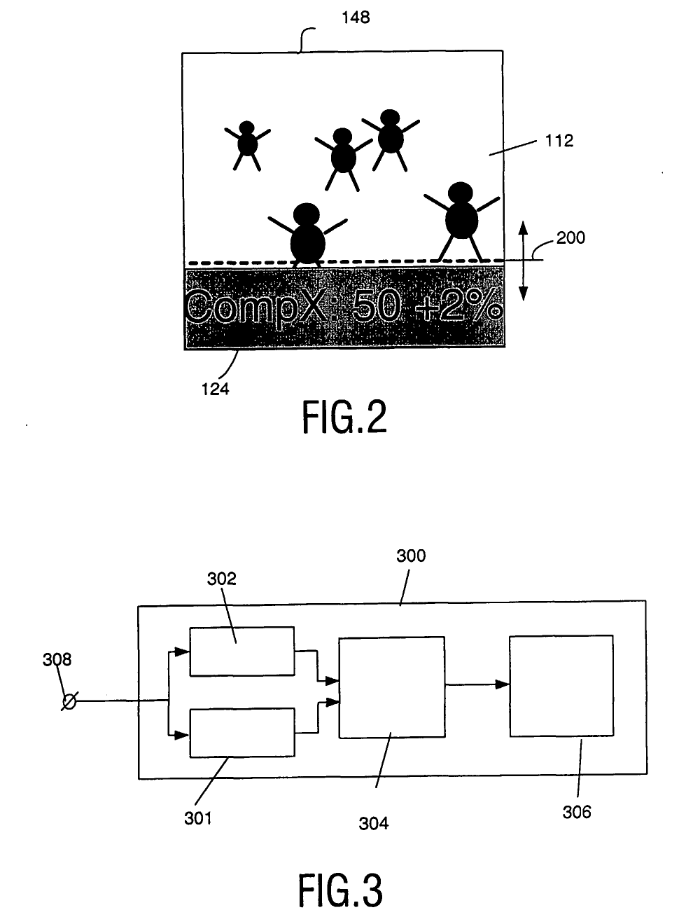

FIG. 2 schematically shows an embodiment of the user interface for the control of the splitting;

FIG. 3 schematically shows an embodiment of the image display apparatus;

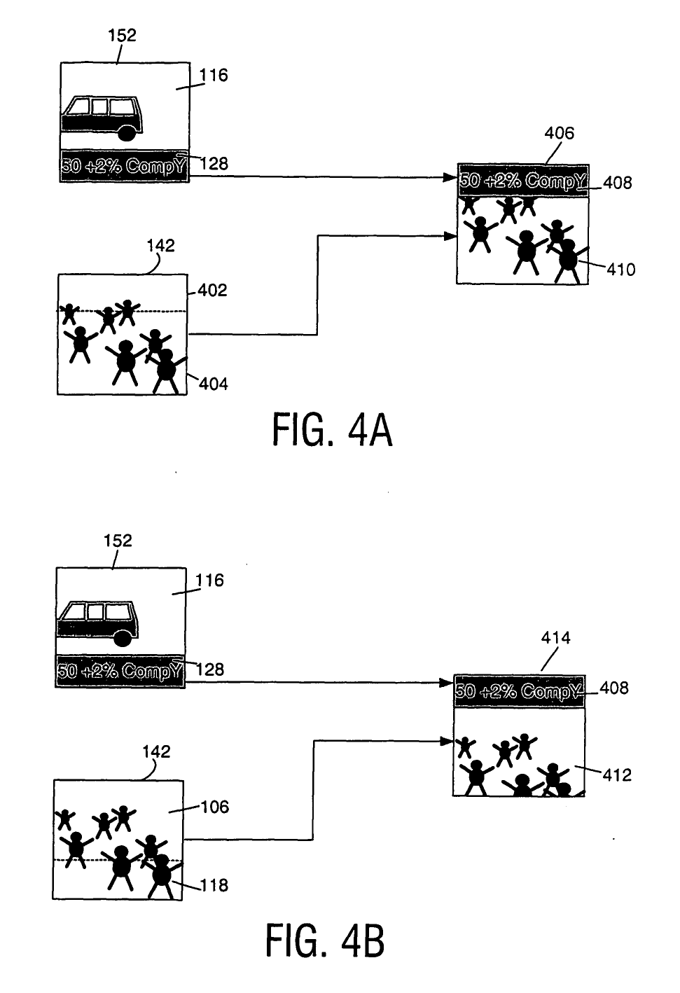

FIG. 4A and 4B schematically show examples of repositioning parts;

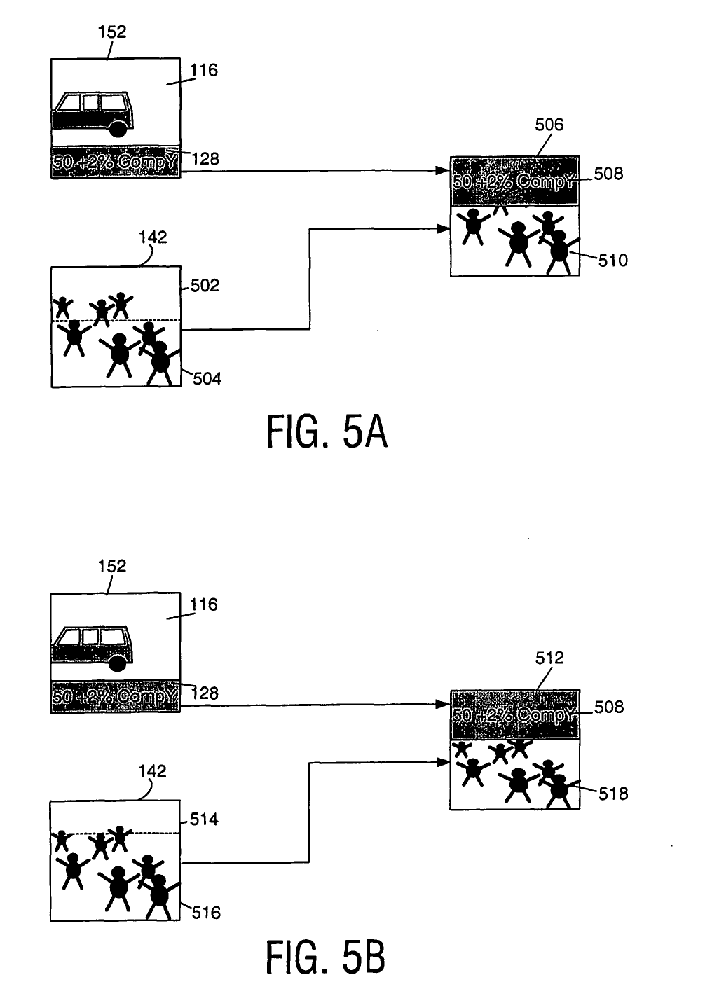

FIG. 5A and 5B schematically show examples of scaling parts; and

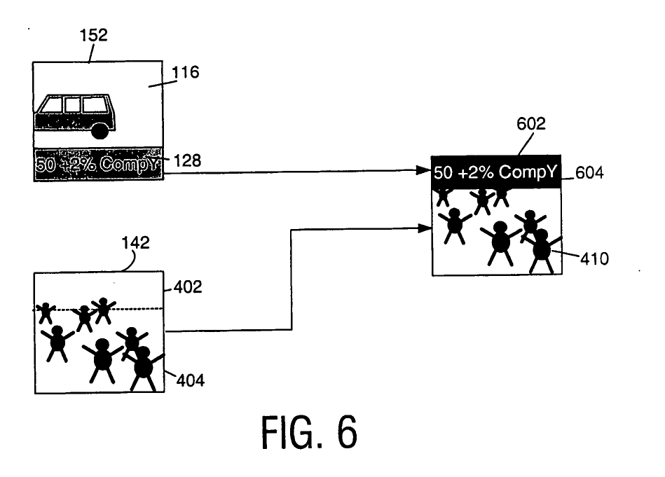

FIG. 6 schematically show an example of color adaptation.

Corresponding reference numerals have same or like meaning in all of the FIGS.

FIG. 1 schematically shows two series 100, 102 of input images 142-152 and a series 104 of output images 154-158 according to the invention. The images 142-146 represent a portion of a sport game. The images 148-152 represent a portion of a car program. Besides that, textual information is provided in the lower parts 124-128 of the images 148-152. A first one 158 of the consecutive output images 154-158 comprises a first part 134 which corresponds to a first block of connected pixels 110 of a first one 146 of the first series of consecutive input images 142-146, and a second part 140 which corresponds to a second block of connected pixels 128 of the first one 152 of the second series of consecutive input images 148-152. A second one 156 of the consecutive output images 154-158 comprises a first part 132 which corresponds to a third block of connected pixels 108 of a second one 144 of the first series of consecutive input images 142-146, and a fourth part 138 which corresponds to a fourth block of connected pixels 126 of the second one 150 of the second series of consecutive input images 148-152. Hence, the output images 154-158 comprise blocks of pixels 130-134 which correspond to the first parts 106-110 of the respective input images 142-146 of the first series and comprise blocks of pixels 136-140 which correspond to the fourth parts 124-128 of the respective input images 148-152 of the second series of output images.

FIG. 2 schematically shows an embodiment of the user interface for the control of the splitting between a first part 112 and a second part 124 of the input image 148. On the display device 306 a graphics line 200 is drawn as an overlay of the input image 148. The user of the image display apparatus 300 can adapt the position of the line by means of pushing a plus or minus button of the remote control of the image display apparatus 300.

Such manipulation of the display can be achieved using the facilities of the OSD (On Screen Display) features of the display apparatus 300 and or other graphics features of the display apparatus 300. The position of the line 200, corresponds to the location information which is required to split the images 148-152 of the series 102 of input images in first parts 112-116 and second parts 124-128. Optionally the position of the line 200 is stored in a memory device. Preferably multiple instances are stored, e.g. a first position for channel 1, a second position for channel 2, etcetera.

FIG. 3 schematically shows an embodiment of the image display apparatus 300 comprising:
a first receiving means 301 for receiving a signal representing input images 142-146 of the first series 100 of consecutive input images. The signal may be a broadcast signal received via an antenna or cable but may also be a signal from a storage device like a VCR (Video Cassette Recorder) or Digital Versatile Disk (DVD). The signal is provided at the input connector 308. The first receiving means is arranged to be tuned to a first predetermined frequency band to extract the input images 142-146 from the provided signal.
a second receiving means 302 for receiving a signal representing input images 148-152 of the second series 102 of consecutive input images. The second receiving means is arranged to be tuned to a second predetermined frequency band to extract the input images 148-152 from the provided signal.
processing means 304 for making the output images 154-158 on basis of the input images 142-152. The processing means 304 comprises memory devices for buffering incoming data, i.e. pixel values of input images. The pixel values which are required to make an output image 154-158 have to be read from the memory device in the appropriate order.
display means for displaying the output images 110-114. This display means is optional. The functionality can also deployed by making use of a e.g. Set-top box. In that case the displaying is done by a Television and other parts of the processing by means the Set-top box.

FIG. 4A schematically shows an example of repositioning a part 128. FIG. 4A shows that output image 406 comprises a first block of pixels 410 located at the lower side of the output image 406. This first block of pixels 410 corresponds to a first part 404 which is located in the lower part of a first image 142 of the first series 100 of input images. Output image 406 also comprises a second block of pixels 408 located at the upper side of the output image 406. This second block of pixels 408 corresponds to a fourth part 128 which is located in the lower part of a first image 152 of the second series 102 of input images. This repositioning can easily be done by means of a memory device.

FIG. 4B schematically shows an example of repositioning parts 128 and 106. FIG. 4B shows that output image 414 comprises a first block of pixels 412 located at the lower side of the output image 414. This first block of pixels 412 corresponds to a first part 106 which is located in the upper part of a first image 142 of the first series 100 of input images. Output image 414 also comprises a second block of pixels 408 located at the upper side of the output image 414. This second block of pixels 408 corresponds to a fourth part 128 which is located in the lower part of a first image 152 of the second series 102 of input images.

FIG. 5A schematically shows an examples of scaling a part 128. FIG. 5A shows that output image 506 comprises a first block of pixels 510 located at the lower side of the output image 506. This first block of pixels 510 corresponds to a first part 504 which is located in the lower part of a first image 142 of the first series 100 of input images. Output image 506 also comprises a second block of pixels 508 located at the upper side of the output image 506. This second block of pixels 508 corresponds to a vertically scaled fourth part 128 which is located in the lower part of a first image 152 of the second series 102 of input images. The fourth part 128 is enlarged.

FIG. 5B schematically shows an examples of scaling parts 128 and 516. FIG. 5A shows that output image 512 comprises a first block of pixels 518 located at the lower side of the output image 512. This first block of pixels 518 corresponds to a vertically scaled first part 516 which is located in the lower part of a first image 142 of the first series 100 of input images. Output image 512 also comprises a second block of pixels 508 located at the upper side of the output image 512. This second block of pixels 508 corresponds to a vertically scaled fourth part 128 which is located in the lower part of a first image 152 of the second series 102 of input images. The fourth part 128 is enlarged while the first part 516 is reduced.

In the case that viewer sees an interesting subject in either the lower side or the upper side of the output image, the user can switch to the corresponding channel of interest by a minimum of interaction. This will be illustrated by means of some examples. Assume the case that a viewer is looking at a news channel with the banner from MTV (Music). The viewer is waiting for a interesting song on the banner from MTV, but is watching the news.

The viewer will wish to switch rapidly from the viewed channel to the channel with the banner. This will need to be one button push away and not via channel zapper, which could take you through a number of channels. Similar to the example above but slight more advanced. In this case the viewer is waiting for a song on the banner, but does not wish to move to view the MTV channel, but wish to listen to the sound from that channel. This could also be one button mode. Or the viewer may wish to switch from split channel-banner viewing of a channel to PIP (picture in picture) mode with both channels on display.

FIG. 6 schematically show an example of color adaptation. FIG. 6 shows that output image 602 comprises a first block of pixels 410 located at the lower side of the output image 406. This first block of pixels 410 corresponds to a first part 404 of a first image 142 of the first series 100 of input images. Output image 406 also comprises a second block of pixels 604 located at the upper side of the output image 406. This second block of pixels 604 is derived from a fourth part 128 of a first image 152 of the second series 102 of input images. The pixel values of the second block of pixels 604 are determined by means of a LUT operation with the pixel values of the fourth part 128 as input operands. Color adaptation might also mean rendering of the banner in grey-scale or black and white.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. An image display apparatus (300) comprising:
first receiving means (302) for receiving a first video signal representing a first series (100) of consecutive input images (142-146);
second receiving means (301) for receiving a second video signal representing a second series (102) of consecutive input images (148-152); and
a display device (306) for displaying a third series (104) of consecutive output images (154-158) which are based on the first series (100) of consecutive input images (142-146) and the second series (102) of consecutive input images (148-152), characterized in that the image display apparatus (300) is arranged:
to split the images (142-146) of the first series (100) of consecutive input images (142-146) into first parts (106-110) and respective second parts (118-122);
to split the images (148-152) of the second series (102) of consecutive input images (148-152) into third parts (112-116) and respective fourth parts (124-128); and
to display a first one (158) of the output images (154-158) comprising a first block of pixels (134) corresponding to a first one (110) of the first parts (106-110) and a second block of pixels (140) corresponding to a first one (128) of the fourth parts (124-128).

2. An image display apparatus (300) as claimed in claim 1, characterized in that the fourth parts (124-128) correspond to respective portions of a banner.

3. An image display apparatus (300) as claimed in claim 1, characterized in that the fourth parts (124-128) correspond to a subtitle.

4. An image display apparatus (300) as claimed in claim 1, characterized in comprising user interface means (200) to provide location information of the fourth parts (124-128) to control splitting of the images of the second series (102) of consecutive input images (148-152).

5. An image display apparatus (300) as claimed in claim 4, characterized in comprising a first memory device for storage of the location information.

6. An image display apparatus (300) as claimed in claim 1, characterized in comprising scaling means to scale the first parts (106-110).

7. An image display apparatus (300) as claimed in claim 1, characterized in comprising processing means to assign a new color value to a first pixel of the second block of pixels (604) on basis of an original color value of the first pixel.

8. A method of displaying a third series (104) of consecutive output images (154-158) which are based on a first series (100) of consecutive input images (142-146) and a second series (102) of consecutive input images (148-152), comprising:
a first receiving step of receiving a first video signal representing the first series (100) of consecutive input images (142-146); and
a second receiving step of receiving a second video signal representing the second series (102) of consecutive input images (148-152), characterized in that the method comprises:
a first splitting step of splitting the images (142-146) of the first series (100) of consecutive input images (142-146) into first parts (106-110) and respective second parts (118-122);
a second splitting step of splitting the images (148-152) of the second series (102) of consecutive input images (148-152) into third parts (112-116) and respective fourth parts (124-128); and
a display step of displaying a first one (158) of the output images (154-158) comprising a first block of pixels (134) corresponding to a first one (110) of the first parts (106-110) and a second block of pixels (140) corresponding to a first one (128) of the fourth parts (124-128).

9. TV comprising an image display apparatus (300) according to claim 1.
